(19) United States
(12) Patent Application Publication
(10) Pub. No.: US 2011/0034571 A1
(43) Pub. Date: Feb. 10, 2011

(54) FOAMS HAVING HIGH FLAME RETARDANCY AND LOW DENSITY

(75) Inventors: Klaus Hahn, Kirchheim (DE); Armin Alteheld, Bad Kreuznach (DE); Benjamin Nehls, Ludwigshafen (DE); Bernhard Schmied, Frankenthal (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE, Ludwigshafen (DE)

(21) Appl. No.: 12/920,692

(22) PCT Filed: Mar. 2, 2009
(86) PCT No.: PCT/EP2009/052428

§ 371 Date: Sep. 2, 2010

(30) Foreign Application Priority Data
Mar. 4, 2008 (EP) 08152240.1

(51) Int. Cl. C08J 9/00

(52) U.S. Cl. 521/50.5; 521/70

(57) ABSTRACT

A process for the production of a foam by curing a beaten or blown foam comprising an aqueous composition, the aqueous: composition comprising
A) from 40 to 95 parts by weight of an alkali metal silicate solution having a water content of from 40 to 90% by weight,
B) from 0 to 60 parts by weight of a pulverulent alkali metal silicate having a water content of from 0 to 30% by weight,
C) from 0 to 15 parts by weight of a surfactant,
D) from 5 to 40 parts by weight of an aqueous polymer dispersion having a solids content of from 10 to 60% by weight,
   and the foams obtainable by the process and the use thereof as an insulation panel.

The invention relates to a process for the production of a foam by curing a beaten or blown foam comprising an aqueous composition, the aqueous composition comprising
A) from 40 to 95 parts by weight of an alkali metal silicate solution having a water content of from 40 to 90% by weight,
B) from 0 to 60 parts by weight of a pulverulent alkali metal silicate having a water content of from 0 to 30% by weight,
C) from 0 to 15 parts by weight of a surfactant,
D) from 5 to 40 parts by weight of an aqueous polymer dispersion having a solids content of from 10 to 60% by weight,
   and the foams obtainable by the process and the use thereof as an insulation panel.

Inorganic foams based on aluminosilicates are disclosed, for example, in EP-A 1 423 346 and WO 2007/048729.

WO 2007/023089 states that expandable polystyrene (EPS) can be adhesively bonded to a foam slab by the use of a binder based on an aqueous silicate solution with addition of a hydrophobic polymer dispersion. Said foam slab is distinguished by flame retardancy. Owing to the high density of the water-containing binder system substantially comprising inorganic constituents, the slabs obtained have substantially higher densities than standard EPS slabs without binder. Consequently, the higher densities lead to poorer handling of the resulting molding materials and poorer heat insulation.

It was an object of the present invention to provide a foam having high flame retardancy and low density and a process for the production thereof.

Accordingly, the process described above and the foams obtainable by the process were found.

From 40 to 95 parts by weight, preferably from 50 to 70 parts by weight, of an alkali metal silicate solution, in particular waterglass solution having a water content of from 40 to 90, preferably from 50 to 70, % by weight are used as component A.

From 0 to 60 parts by weight, preferably from 30 to 50 parts by weight, of a pulverulent alkali metal silicate, in particular waterglass powder having a water content of from 0 to 30, preferably from 1 to 25, % by weight, are used as component B).

Preferably a water-soluble alkali metal silicate having the composition M₂O(SiO₂)ₙ where M=sodium or potassium and n=1 to 4, or mixtures thereof is or are used as the alkali metal silicate.

It is advantageous to use from 0 to 15 parts by weight, preferably from 1 to 10 parts by weight, of a surfactant or combinations of a plurality of surfactants as component C) for producing and stabilizing the foam generated from the binder.

The surfactant system should be compatible with the polymer dispersion. Surfactant systems which are suitable for producing and stabilizing aqueous foams in alkaline media and at high electrolyte concentrations are particularly advantageous.

Surfactants which may be used are anionic, cationic, nonionic or ambivalent surfactants or mixtures thereof. Both low molecular weight and polymeric surfactants may be used.

Nonionic surfactants are, for example, adducts of alkylene oxides, in particular ethylene oxide, propylene oxide and/or butylene oxide, with alcohols, amines, phenols, naphthols or carboxylic acids. Adducts of ethylene oxide and/or propylene oxide with alcohols comprising at least 10 carbon atoms are advantageously used as surfactants, the adducts comprising from 3 to 200 mol of ethylene oxide and/or propylene oxide incorporated by an addition reaction per mole of alcohol. The adducts comprise the alkylene oxide units in the form of blocks or in random distribution. Examples of nonionic surfactants are the adducts of % mol of ethylene oxide with 1 mol of tallow fatty alcohol, reaction products of 9 mol of ethylene oxide with 1 mol of tallow fatty alcohol and adducts of 80 mol of ethylene oxide with 1 mol of tallow fatty alcohol.

Further commercially available nonionic surfactants consist of reaction products of oxo alcohols or Ziegler alcohols having 5 to 12 mol of ethylene oxide per mole of alcohol, in particular having 7 mol of ethylene oxide. Further commercially available nonionic surfactants are obtained by ethoxylation of castor oil. For example, from 12 to 80 mol of ethylene oxide are incorporated by an addition reaction per mole of castor oil. Further commercially available products are, for example, the reaction products of 18 mol of ethylene oxide with 1 mol of tallow fatty alcohol, the adducts of 10 mol of ethylene oxide with 1 mol of a C₁₃/C₁₅-oxo alcohol or the reaction products of from 7 to 8 mol of ethylene oxide with 1 mol of a C₁₃/C₁₅-oxo alcohol.

Further suitable nonionic surfactants are phenol alkoxylates, such as, for example, p-tert-butylphenol, which is reacted with 9 mol of ethylene oxide, or methyl ethers of reaction products of 1 mol of a C₁₂/C₁₈-alcohol and 7.5 mol of ethylene oxide.

Further suitable nonionic surfactants are alkoxylated, preferably ethoxylated, silicones. Water-soluble silicone surfactants which are obtained by reacting short-chain silicones (dimethicones) with a high molar proportion of ethylene oxide are preferred here.

The surfactants described above can be converted into the corresponding sulfuric acid monoesters, for example by esterification with sulfuric acid. The sulfuric acid monoesters are used as anionic surfactants in the form of the alkali metal or ammonium salts. Suitable anionic surfactants are, for example, alkali metal or ammonium salts of sulfuric acid monoesters of adducts of ethylene oxide and/or propylene oxide with fatty alcohols, alkali metal or ammonium salts of alkylbenzenesulfonic acid or alkylphenol ether sulfates. Products of said type are commercially available.

Cationic surfactants are also suitable. Examples of these are the reaction products of 6.5 mol of ethylene oxide with 1 mol of oleylamine which are quaternized with dimethyl sulfate, distearyldimethyl ammonium chloride, lauryltrimethylammonium chloride, cetylpyridinium bromide and stearic acid triethanolamine esters quaternized with dimethyl sulfate. Owing to interactions with anionic silicates, exclusively cationic surfactants are frequently not suitable for foam stabilization. The combination of cationic surfactants with anionically stabilized polymer latex can lead to destabilization of the dispersion.

The surfactants are present in the aqueous composition preferably in an amount in a range from 0.1 to 15 parts by weight, particularly preferably in a range from 1 to 10 parts by weight, based in each case on the weight of the aqueous composition.

Stabilizers, thickeners, fillers or cell nucleating agents or mixtures thereof can be used as assistants in the process according to the invention. It may be advantageous to use additional thixotropic agents which permit, for example, control of the viscosity of the binder to be foamed. These additives may be of an organic or inorganic nature. Frequently used additives are, for example, phyllosilicates, polyphosphates, polyvinyl alcohol, polyvinylpyrrolidone, etc. It is advantageous if these additives have no adverse effects with regard to the fire properties.

Thickeners are used, for example, for optimizing the foam structure and for improving the foam stability. Suitable thickeners are all natural and synthetic polymers which are known for this purpose and considerably increase the viscosity Of an aqueous system. These may be water-swellable or water-soluble synthetic or natural polymers. Pulverulent superabsorbers are also suitable as thickeners.

Preferably used fillers are chalks, bentonites, talc, gypsum, alumina, aluminum hydroxides, boric acid and borates, cement, silica gels or silica, active carbons, graphites, calcium oxide, zinc oxide, aluminophosphates, borophosphates, pigments, such as titanium dioxide and iron oxide, or mixtures thereof. It is also possible to use intumescent additives, e.g. expandable graphite or carbohydrates.

For increasing the thermal stability and flame retardancy of the foam, a clay mineral may be added as an assistant to the aqueous composition. Particularly suitable clay minerals are minerals comprising allophane Al₂[SiO₅]&O₃.n H₂O, kaolinite Al₄[(OH)₈|Si₄O₁₀], halloysite Al₄[(OH)₈ |Si₄O₁₀].2 H₂O, montmorillonite (smectite) (Al,Mg,Fe)₂[(OH₂|(Si,Al)₄O₁₀].Na_{0.33}(H₂O)₄, vermiculite Mg₂(Al,Fe,Mg)[(OH₂|(Si,Al)₄O₁₀].Mg_{0.35}(H₂O)₄ or mixtures thereof. Kaolin is particularly preferably used. As a rule, the weight ratio of clay mineral to alkali metal silicate, based on solids, in the aqueous composition is in the range from 1:2 to 2:1 if clay minerals are used.

For improving the distribution of the fillers and for increasing the flowability, dispersants (e.g. Sokalan types of BASF SE) may be added.

The aqueous composition may comprise water-repellent additives, for example paraffins, silicones, aluminum stearates or the like. In the case of these additives, it should be ensured that they do not lead to defoaming.

The assistants are present in the aqueous composition preferably in an amount in a range from 0.01 to 80 parts by weight, particularly preferably in a range from 0.05 to 10 parts by weight and additionally preferably in a range from 0.1 to 5 parts by weight, based in each case on the weight of the aqueous composition.

A viscosity increase for better foamability can also be effected by the addition of electrolytes, or special surfactants or by changing the pH, the temperature or the concentration.

From 5 to 40 parts by weight, preferably from 10 to 30 parts by weight, of a polymer dispersion having a solids content of from 10 to 60% by weight, preferably from 20to 50% by weight, are used as component D).

In the process according to the invention, an aqueous polymer dispersion which, after drying, leads to a dried polymer film having a glass transition temperature in the range from −60 to +100° C., preferably in the range from −30 to +80° C., particularly preferably in the range from −10 to +60° C., is preferably used as component D) of the aqueous composition. The glass transition temperature can be determined by Differential Scanning Calorimetry (DSC).

It is also possible to use dispersions of block copolymers or mixtures of different polymer dispersions which have two or more glass transition temperatures. For example, a combination of low film formation temperature with high mechanical stability, better compatibility or high hydrophobicity may be possible as a result.

For example, polymers based on monomers, such as vinylaromatic monomers, such as α-methylstyrene, p-methylstyrene, ethylstyrene, tert-butylstyrene, vinylstyrene, vinyltoluene, 1,2-diphenylethylene, 1,1-diphenylethylene, alkenes, such as ethylene or propylene, dienes, such as 1,3-butadiene, 1,3-pentadiene, 1,3-hexadiene, 2,3-dimethylbutadiene, isoprene, piperylene or isoprene, α,β-unsaturated carboxylic acids, such as acrylic acid and methacrylic acid, esters thereof, in particular alkyl esters, such as C₁₋₁₀-alkyl esters of acrylic acid, in particular the butyl esters, preferably n-butyl acrylate, and the C₁₋₁₀-alkyl esters of methacrylic acid, in particular methyl methacrylate (MMA), or carboxamides, for example acrylamide and methacrylamide, are suitable as component D).

The polymers can, if appropriate, comprise from 1 to 5% by weight of comonomers, such as (meth)acrylonitrile, (meth)acrylamide, ureido(meth)acrylate, 2-hydroxyethyl (meth)acrylate, 3-hydroxypropyl (meth)acrylate, acrylamidopropanesulfonic acid, methylolacrylamide or the sodium salt of vinylsulfonic acid.

The polymers are preferably composed of one or more of the monomers styrene, butadiene, acrylic acid, methacrylic, acid, C₁₋₄-alkyl acrylates, C₁₋₄-alkyl methacrylates, acrylamide, methacrylamide and methylolacrylamide.

Particularly suitable polymers are acrylate resins, which are used according to the invention as aqueous polymer dispersions, if appropriate additionally with hydraulic binders based on cement, lime cement or gypsum. Suitable polymer dispersions are obtainable, for example, by free radical emulsion polymerization of ethylenically unsaturated monomers, such as styrene, acrylates or methacrylates, as described in WO 00/50480.

Pure acrylates or styrene-acrylates which are composed of the monomers styrene, n-butyl acrylate, methyl methacrylate (MMA), methacrylic acid, acrylamide or methylolacrylamide are particularly preferred.

The polymer dispersion is prepared in a manner known per se, for example by emulsion, suspension or dispersion polymerization, preferably in the aqueous phase. The polymer can also be prepared by solution or mass polymerization and, if appropriate, comminuted and the polymer particles can then be dispersed in water in the customary manner. In the polymerization, the initiators, emulsifiers or suspension auxiliaries, regulators or other assistants customary for the respective polymerization process are concomitantly used; and polymerization is effected continuously or batchwise at the temperatures and pressures customary for the respective process, in customary reactors.

The aqueous composition preferably consists of the components A), B) and D) or A), C) and D) or A), B), C) and D), the components A) and B) summing to 100 parts.

For the preparation of the aqueous composition used in the process according to the invention, the components A), B), C) and D) can be mixed in any desired sequence.

According to a further development of the process according to the invention, foam particles comprising a thermoplastic polymer may be added to the beaten or blown foam before the curing. By the addition of the foam particles, the insulating power of the inorganic foam can be improved.

The foam particles can be added to the aqueous composition before or after the foam formation. Preferably, the foam particles are mixed last with the prepared mixture of A), B), C) and D).

In the variant with preparation of a beaten foam from the components A), B), C) and D), the beaten foam is preferably first produced and is then mixed with the foam particles.

In the variant of a blown foam comprising the components A), B), C) and D), the foam particles are preferably added to the aqueous composition of the components A), B), C) and D) and the mixture is then foamed.

The foam particles used are preferably expanded polyolefin, in particular expanded polypropylene (EPP), expanded polyethylene (EPE) or preexpanded particles of expandable styrene polymers (EPS). It is also possible to use combinations of different foam particles. These are preferably thermoplastic materials. It is also possible to use crosslinked polymers, for example radiation-crosslinked polyolefin foam bodies.

The foam particles based on styrene polymers can be obtained by preexpansion of EPS with hot air or steam in a preexpander to the desired density. By preexpansion once or several times in a pressure preexpander or continuous preexpander, it is possible to obtain final bulk densities below 10 g/l thereby.

For the production of insulation panels having a high heat insulation capability, preexpanded, expandable styrene polymers which comprise athermal solids, such as carbon black, aluminum, graphite or titanium dioxide, in particular graphite having a mean particle size in the range from 1 to 50 μm particle diameter, in amounts of from 0.1 to 10% by weight, in particular from 2 to 8% by weight, based on EPS, and are disclosed, for example, in EP-B 981 574 and EP-B 981 575 are particularly preferably used.

Furthermore, foam particles based on α-methylstyrene/acrylonitrile copolymer (AMSAN) having high solvent resistance or resilient foam particles based on multiphase blends of styrene polymers and polyolefins can be used.

In the process, comminuted foam particles of recycled foam moldings can also be used. For the production of the foam moldings according to the invention, the comminuted recycled foam materials can be used in an amount of 100% or, for example, in proportions of from 2 to 90% by weight, in particular from 5 to 25% by weight, together with fresh product, without substantially impairing the strength and the mechanical properties.

The foam particles can be provided with a surface'impregnation in order, for example, to improve the binding to the water-containing system.

By the addition of the foam particles to the aqueous composition, hybrid foams comprising the substantially organic foam particles and the substantially inorganic foam matrix formed from the aqueous composition can be obtained. Hybrid foams which comprise from 50 to 99% by volume, preferably from 60 to 80% by volume, of foam particles of thermoplastic polymer and from 1 to 50% by volume, preferably from 20 to 40% by volume, of a foam based on silicates, which is obtainable by curing a beaten or blown foam comprising the aqueous composition described above, are preferred.

The density of the foam based on silicates is as a rule below 1000 kg/m³, preferably in the range from 100 to 500 kg/m³. Depending on the proportion of foam particles in the hybrid foam, the hybrid foam has a density in the range from 10 to 1000 kg/m³, preferably in the range from 100 to 300 kg/m³.

The introduction of a cell gas into the binder to be foamed or the foam being formed can be effected in various ways.

The foaming of the aqueous composition is preferably effected by mechanical actions, in particular shearing, particularly preferably by vigorous stirring or mixing comprising mixing with air. However, according to the invention, it is also possible to foam the composition by the dispersion of an inert gas in the form of fine gas bubbles. The introduction of gas bubbles into the aqueous composition is effected, for example, with the aid of beating, shaking, stirring or whipping apparatuses.

Furthermore, it is also possible to foam the composition by a procedure in which gases flow out of a liquid-covered opening or by utilizing turbulence phenomena in flows. Furthermore, the formation of lamellae on wires or screens can also be used for this purpose. These different methods can, if appropriate, also be combined with one another. Suitable inert gases are, for example, nitrogen, carbon dioxide, helium, neon and argon.

For the preparation of the beaten foam, a gas, preferably air, is introduced into the aqueous composition, if appropriate with additives and before the introduction of polymer foam particles. This can be effected, for example, by a suitable mixer, dispenser or a porous membrane. Thermoplastic foam particles, for example preexpanded EPS particles, can then be introduced into the beaten foam formed and freely foamed in a mold or, if appropriate, pressed. Pressing is advisable in particular in the case of relatively high proportions of foam particles.

A gaseous substance which leads to a volume increase after letting down to atmospheric pressure can also be added as a physical blowing agent to the binder under pressure. It is also possible to use a liquid which goes over into the gaseous state of aggregation as a result of changes in the pressure or the temperature. The substance may be present as a homogeneous solution in the substantially aqueous binder (e.g. methanol, ethanol, isopropanol, CO₂, methyl formate or ethyl formate) or may form separate phases, e.g. pentane, etc. In the case of multiphase systems, the use of a dispersant is advantageous.

It is also possible to use chemical blowing agents which form a gas, for example on the basis of chemical decomposition processes; for example, carbonates, azides, hydrazides, hydroxides or peroxides. The liberation of the gas can be effected by reaction of one, two or more components and initiated by changing the ambient conditions, e.g. the temperature. Further examples are acids or acid anhydrides in combination with carbonates or isocyanates in combination with water.

In order to prevent collapsing of the aqueous foam obtained from the binder, curing for fixing the foam structure is advantageous. This can be achieved in various ways.

For example, the solidification of the inorganic fraction can be achieved by gelling and SiO₂ formation, which ideally results in solidification after formation of the foam. The curing methods customary for waterglass, for example ester curing by means of triacetin, diacetin or the like, aluminum-containing salts, CO₂ introduction or acid formation from anhydrides, can be used for this purpose.

It may also be advantageous to generate the solidification by organic systems which may also be part of a system producing water repellency. It is advantageous if these systems are soluble or dispersible in aqueous media. Examples of such systems are self-crosslinking dispersions, for example ester formation or water-dispersible isocyanates in combination with functional dispersions or dissolved reactants.

The use of crosslinking isocyanates having a functionality above 1 is particularly advantageous. The beginning of the reaction can be controlled via the addition of small amounts of oligo alcohols/polyalcohols. By simultaneously eliminating CO₂, the isocyanates can simultaneously also be used as blowing agents and curing agents for the waterglass-containing inorganic foam. In this way, particularly thermally stable foams are obtained.

It is particularly advantageous if the crosslinking is effected below the softening temperature of the particle foam. The reaction can be adjusted through the choice of the reactants, the concentration thereof and catalysts. For example, water-dispersible isocyanates can be reacted with amino-functionalized polymers, the reaction rate with primary amines being substantially higher than with secondary amines. However, both reactions take place more rapidly than a reaction with water.

The heating of the foamed composition is preferably effected in an oven, a drying oven, with a hot gas stream, by infrared irradiation or by microwave radiation.

The microwave radiation is not only suitable for curing the foam but can also . . . foaming or subsequent foaming of the dried or still moist aqueous composition of the components A), B) and C), to which, if appropriate, foam particles have been added.

In a preferred embodiment of the process according to the invention, the foamed composition, before it is heated, is first converted into a molding. In a further preferred embodiment, the aqueous composition is converted into a molding prior to foaming and then foamed in this molding. With subsequent heating of the foamed composition in this molding, it is subsequently possible to obtain foam-like textures having a defined three-dimensional structure.

The thickness, length and width of the foam slabs can be varied within wide limits and is limited by the size and clamping pressure of the mold. The thickness of the foam slabs is usually from 1 to 500 mm, preferably from 10 to 300 mm.

The density of the foam moldings according to DIN 53420 is as a rule from 10 to 500 kg/m³, preferably from 30 to 300 kg/m³.

The curing and drying of the foamed binder can optionally be effected continuously or batchwise by means of an oven or in a hot air stream. The curing of the foam is preferably effected with air or nitrogen at a temperature in the range from 0 to 80° C. Furthermore, the curing and/or foaming can be effected by exposure to microwave radiation.

Alternatively or additionally, the sintering and/or foaming can be effected continuously or batchwise with incidence of microwave energy. As a rule, microwaves in the frequency range from 0.85 to 100 GHz, preferably from 0.9 to 10 GHz, and irradiation times of from 0.1 to 15 minutes are used. Thus, foam slabs having a thickness of more than 5 cm can also be produced.

The irradiation of the mixture to be cured can be carried out in a treatment chamber. In the case of a batchwise procedure, the treatment chamber is closed on all sides. In the case of a continuous procedure, the mixture would be transported past the radiation source on a continuously running belt. If the preexpanded foam particles also comprise a blowing agent which boils below the vaporization temperature of water, the resulting steam can be utilized for subsequent foaming of the EPS beads.

The postcuring of foam particle-containing foams by means of microwave radiation is particularly preferred in the production of foam slabs having a thickness of more than 5 cm. Owing to the material density and the insulating effect of any foam particles added, exclusively thermal curing of the material (crosslinking of the matrix material) is substantially delayed.

The hybrid foams according to the invention can be obtained by different process variants. A preferred process (A1) with the use of a beaten foam comprises the stages:
i) preexpansion of expandable styrene polymers to give foam particles,
ii) preparation of a beaten or blown foam from an aqueous composition of the components A), B), C) and D),
iii) addition of the foam particles preexpanded in stage i) to the foam prepared in stage ii),
iv) curing of the resulting foam with air or nitrogen at a temperature in the region of 80° C. or by means of microwaves.

The inorganic foam obtainable by the process according to the invention is distinguished by high flame retardancy and a low density. Pressing under high pressure in the mold is not necessary.

A further process (A2) for the preparation of the hybrid foam according to the invention with the use of microwave radiation comprises the stages:
i) addition of foam particles to an aqueous composition of the components A), B), C) and D) and, if appropriate, further assistants,
ii) formation of a molding by drying the mixture from stage i) in a mold,
iii) foaming of the molding by means of microwave radiation,
iv) if appropriate, postcuring of the molding.

The purely inorganic foams obtainable by addition of thermoplastic foam particles have, as a rule, better flame retardancy, mechanical properties and abrasiveness. In order to obtain these materials, it is possible, according to a further embodiment of the invention, first to prepare a foam by the processes according to the invention with the use of foam particles and to remove these after the curing. This is possible by thermal decomposition of the particle foam or by extraction with a suitable solvent. The thermoplastic foam particles are preferably extracted.

Depending on the desired properties of the inorganic foams, thermal decomposition or extraction of the particle foams can be effected even from a silicate matrix having a high density. Suitable particle foam-containing slabs are described, for example, in WO 2007/023089 or PCT/EP2007/060541.

The organic component is removed and leaves behind a substantially inorganic foam structure whose cavities are predetermined by the particle size of the organic foam particles used beforehand. If EPS foam particles are used, cavities of 0.4-10 mm, preferably 1-6 mm, can be produced.

By thermal decomposition or extraction of the foam particles from the hybrid foam according to the invention which comprises cured beaten or blown foam, inorganic foam moldings whose struts have a foamed substructure can be produced.

The foam moldings (“lost foam”) obtained in this manner are preferably postcured, for example by acid catalysis or thermal sintering.

In addition to the construction applications described here, such foam bodies described above can also be used as “screens” for high temperature applications. By the use of different foam particle sizes, it is in fact possible to establish the screen size very exactly.

Suitable solvents are, for example, dichloromethane or toluene, in particular for dissolving the preferably used foam particles comprising expandable polystyrene out of the inorganic matrix. Owing to the usually small proportions by weight of foam particles in the inorganic foam, small amounts of solvents are sufficient. The solvents can be recycled in a circulation, for example by extraction in a Soxhlet apparatus.

The process according to the invention is suitable for the production of simple or complex shaped foam articles, such as slabs, blocks, pipes, rods, profiles, etc. Slabs or blocks which can subsequently be sawn or cut into panels are preferably produced. They can be used, for example, in the building industry for insulating exterior walls or flat roofs. They are particularly preferably used as a core layer for the production of a sandwich element, for example so-called structural insulation panels (SIP), which are used for the erection of cold stores or warehouses.

Further potential uses are foam pallets as a substitute for wood pallets, visible ceiling panels, cold containers, and trailers. Owing to the outstanding fire resistance, they are also suitable for air freight.

### EXAMPLES

### Example 1

### Foam in Foam (Beaten Foam with Surfactant)

40 parts of waterglass powder (Portil® N) and 4 parts of surfactant (Lutensol® GD70) were added in portions to 60 parts of a waterglass solution (37% strength, Woellner sodium silicate). The solution is beaten to a foam with a stirrer (Ultraturrax). 5 parts of dispersion (Acronal® SD 705) were then folded in at low speed. 50 g of the solution described above are then added per 1 g of EPS (density 10 g/l) (EPS: coating volume ratio about 76:24).

A very homogeneous, hardened foam having a density of about 270 g/l formed overnight at 40° C.

### Example 2

### Foam in Foam (Microwave Foam with Surfactant)

The foam obtained according to Example 1 was subsequently exposed for about 1 min to microwave radiation (600 W), the foam undergoing further subsequent foaming and the density decreasing to about 200 g/l.

Examples 1 and 2 were also carried out with additions of 2-10 parts of Lutensol® GD70 and with additions of 2-8 parts of EPS.

### Example 3

### Foam in Foam (without Surfactant)

40 parts of waterglass powder (Portil® N) and 5 parts of a dispersion (Acronal® SD 705) are added in portions to 60 parts of a waterglass solution (37% strength, Woellner sodium silicate). The solution was beaten to a foam with a stirrer (Ultraturrax). 50 g of the solution described above are then added per 1 g of EPS (density 10 g/l) (EPS:coating volume ratio about 76:24).

A homogeneous, hardened foam having a density of about 250 g/l formed overnight at 40° C.

### Example 4

### Beaten Foam without EPS

40 parts of waterglass powder (Portil® N) and 8 parts of Lutensol® GD70 are added in portions to 60 parts of a waterglass solution (37% strength, Woellner sodium silicate). The solution was beaten to a foam with a stirrer (Ultraturrax). 5 parts of a dispersion (Acronal® SD 705) are then folded in. After a short stabilization, a foam having a gross density of about 300 g/l results.

### Example 5

### Beaten Foam of Aqueous Waterglass Solution

8 parts of Lutensol® GD70 are added to 60 parts of a waterglass solution (37% strength, Woellner sodium silicate). The solution was beaten to a foam with a stirrer (Ultraturrax). After a short stabilization, a foam having a gross density of about 40 g/l resulted.

### Example 6

### Microwave Foam

40 parts of waterglass powder (Portil® N) and 5 parts of a dispersion. (Acronal® SD 705) are added in portions to 60 parts of a waterglass solution (37% strength, Woellner sodium silicate). The solution was then poured into a round mold (about 5 cm diameter, 4 mm thickness) and dried. After storage for about 2 weeks, the solid disks were exposed to microwave radiation for from 30 to 60 seconds. Depending on the duration of storage or the duration of irradiation, densities of from 250 to 100 g/l were produced thereby.

### Example 7

### Inorganic Foam by Means of Solvent Extraction

10 g of a dispersion (Acronal® S 790) were added to a mixture of 120 g of waterglass solution (37% strength, Woellner sodium silicate) and 80 g of waterglass powder (Portil® N). 46 g of preexpanded EPS (density 10 g/l) were mixed manually into 184 g of the mixture. The coated foam particles (EPS: coating weight ratio 1:4) were introduced into an aluminum mold and compressed by 50% at 70° C. for 60 minutes. A test specimen having an edge length of 5×5 cm was cut out and the organic material present therein was completely extracted with dichloromethane.

1-10. (canceled)

11. A process for the production of a foam by curing a beaten or blown foam comprising, an aqueous composition, comprising
A) from 40 to 95 parts by weight of an alkali metal silicate solution having a water content of from 40 to 90% by weight,
B) from 0 to 60 parts by weight of a pulverulent alkali metal silicate having a water content of from 0 to 30% by weight,
C) from 0 to 15 parts by weight of a surfactant,
D) from 5 to 40 parts by weight of an aqueous polymer dispersion having a solids content of from 10 to 60% by weight,
wherein foam particles comprising thermoplastic polymers are added to the beaten or blown foam before the curing and the curing and/or foaming is effected by exposure to microwave radiation.

12. The process according to claim 11, wherein the curing is additionally effected with air or nitrogen at a temperature in the range from 0 to 80° C.

13. The process according to claim 11, wherein microwaves in a frequency range from 0.85 to 100 GHz and irradiation times of from 0.1 to 15 minutes are used.

14. The process according to claim 11, wherein neutralizing an aqueous polymer dispersion which, after drying, leads to a dried polymer film having a glass transition temperature in the range from −60 to +100° C.

15. The process according to, claim 11, wherein the aqueous composition comprises from 1 to 10 parts by weight of a surfactant as component C).

16. The process according to claim 11, wherein the foam particles used are expanded polyolefins or preexpanded particles of expandable styrene polymers.

17. The process according to claim 11, comprising the stages:
i) preexpansion of expandable styrene polymers to give foam particles,
ii) preparation of a beaten Or blown foam from an aqueous composition of the components A), B), C) and D),
iii) addition of the foam particles preexpanded in stage i) to the foam prepared in stage ii), and
iv) curing of the resulting foam with air or nitrogen at a temperature in the region of 80° C. or by means of microwaves.

18. The process according to claim 11, comprising the stages:
i) addition of foam particles to an aqueous composition of the components A), B), C) and D) and, optionally, further assistants,
ii) formation of a molding by drying the mixture from stage i) in a mold,
iii) foaming of the molding by means of microwave radiation, and
iv) optionally, postcuring of the molding.

19. The process according to claim 11, wherein the thermoplastic foam particles are extracted after the curing with a solvent.

20. A foam having cavities of 0.4 to 10 mm, obtainable by the process according to claim 19.

21. A hybrid foam comprising from 60 to 80% by volume of foam particles of thermoplastic polymer and from 20 to 40% by volume of a foam based on silicates, the hybrid foam having a density in the range from 100 to 300 kg/m³, obtainable by the process according to claim 11

22. The process according to claim 12, wherein neutralizing an aqueous polymer dispersion which, after drying, leads to a dried polymer film having a glass transition temperature in the range from −60 to +100° C.

23. The process according to claim 13, wherein neutralizing an aqueous polymer dispersion which, after drying, leads to a dried polymer film having a glass transition temperature in the range from −60 to +100° C.

24. The process according to claim 12, wherein the aqueous composition comprises from 1 to 10 parts by weight of a surfactant as component C).

24. The process according to claim 13, wherein the aqueous composition comprises from 1 to 10 parts by weight of a surfactant as component C).

24. The process according to claim 14, wherein the aqueous composition comprises from 1 to 10 parts by weight of a surfactant as component C).

25. The process according to claim 12, wherein the foam particles used are expanded polyolefins or preexpanded particles of expandable styrene polymers.

26. The process according to claim 13, wherein the foam particles used are expanded polyolefins or preexpanded particles of expandable styrene polymers.

27. The process according to claim 14, wherein the foam particles used are expanded polyolefins or preexpanded particles of expandable styrene polymers.

28. The process according to claim 15, wherein the foam particles used are expanded polyolefins or preexpanded particles of expandable styrene polymers.

29. The process according to claim 12, comprising the stages:
i) preexpansion of expandable styrene polymers to give foam particles,
ii) preparation of a beaten or blown foam from an aqueous composition of the components A), B), C) and D),
iii) addition of the foam particles preexpanded in stage i) to the foam prepared in stage ii), and
iv) curing of the resulting foam with air or nitrogen at a temperature in the region of 80° C. or by means of microwaves.

30. The process according to claim 13, comprising the stages:
i) preexpansion of expandable styrene polymers to give foam particles,
ii) preparation of a beaten or blown foam from an aqueous composition of the components A), B), C) and D),
iii) addition of the foam particles preexpanded in stage i) to the foam prepared in stage ii), and
iv) curing of the resulting foam with air or nitrogen at a temperature in the region of 80° C. or by means of microwaves.
